(19) United States
(12) Patent Application Publication
(10) Pub. No.: US 2015/0318578 A1
(43) Pub. Date: Nov. 5, 2015

(54) NONAQUEOUS ELECTROLYTE SOLUTION AND ELECTRICAL STORAGE DEVICE EMPLOYING SAME

(71) Applicant: UBE INDUSTRIES, LTD., Ube-shi, Yamaguchi (JP)

(72) Inventors: Koji ABE, Ube-shi (JP); Yuichi KOTOU, Ube-shi (JP)

(73) Assignee: UBE INDUSTRIES, LTD., Ube-shi, Yamaguchi (JP)

(21) Appl. No.: 14/650,096

(22) PCT Filed: Dec. 3, 2013
(86) PCT No.: PCT/JP2013/082499

§ 371 Date: Jun. 5, 2015

(30) Foreign Application Priority Data
Dec. 6, 2012 (JP) 2012-267384

(51) Int. Cl. H01M 10/0569; H01M 10/0525; H01M 4/131; H01M 4/134; H01M 4/525; H01M 4/587; H01M 4/38; H01M 4/485; H01M 4/136; H01M 4/505; H01M 10/0567; H01M 4/133

(52) U.S. Cl. CPC H01M 10/0569; H01M 10/0567; H01M 10/0525; H01M 4/131; H01M 4/134; H01M 4/133; H01M 4/587; H01M 4/387; H01M 4/386; H01M 4/485; H01M 4/136; H01M 4/505; H01M 4/525; H01M 2300/0037; H01M 2004/028

(57) ABSTRACT

Provided are a nonaqueous electrolytic solution having an electrolyte salt dissolved in a nonaqueous solvent, the nonaqueous solvent including a cyclic carbonate and a linear carbonate under the following condition 1 or 2, and the nonaqueous electrolytic solution containing from 0.001 to 5% by mass of vinylsulfonyl fluoride, and an energy storage device using the same. Condition 1: The linear carbonate includes both a symmetric linear carbonate and an asymmetric linear carbonate, and the proportion of the asymmetric linear carbonate occupying in the linear carbonate is from 51 to 95% by volume. Condition 2: The cyclic carbonate includes ethylene carbonate and propylene carbonate, and the linear carbonate includes a symmetric linear carbonate. The nonaqueous electrolytic solution of the present invention is capable of improving electrochemical characteristics in the case of using an energy storage device at a high voltage and further capable of not only improving a discharge capacity retention rate after a high-voltage cycle but also inhibiting gas generation.

### TECHNICAL FIELD

The present invention relates to a nonaqueous electrolytic solution capable of improving electrochemical characteristics on the occasion of using an energy storage device at a high voltage and also an energy storage device using the same.

### BACKGROUND ART

An energy storage device, especially a lithium secondary battery, has been widely used recently for a power source of an electronic device, such as a mobile telephone, a notebook personal computer, etc., and a power source for an electric vehicle or electric power storage. Particularly in a thin electronic device, such as a tablet device, an ultrabook, etc., a laminate-type battery or a prismatic battery using a laminate film, such as an aluminum laminate film, etc., for an outer packaging member is frequently used; however, since such a battery is thin, a problem that the battery is easily deformed due to expansion of the outer packaging member or the like is easily caused, and the matter that the deformation very likely influences the electronic device is problematic.

A lithium secondary battery is mainly constituted of a positive electrode and a negative electrode, each containing a material capable of absorbing and releasing lithium, and a nonaqueous electrolytic solution containing a lithium salt and a nonaqueous solvent; and a carbonate, such as ethylene carbonate (EC), propylene carbonate (PC), etc., is used as the nonaqueous solvent.

In addition, a lithium metal, a metal compound capable of absorbing and releasing lithium (e.g., a metal elemental substance, a metal oxide, an alloy with lithium, etc.), and a carbon material are known as the negative electrode of the lithium secondary battery. In particular, a nonaqueous electrolytic solution secondary battery using, as the carbon material, a carbon material capable of absorbing and releasing lithium, for example, coke or graphite (e.g., artificial graphite or natural graphite), etc., is widely put into practical use. Since the aforementioned negative electrode material stores/releases lithium and an electron at an extremely electronegative potential equal to the lithium metal, it has a possibility that a lot of solvents are subjected to reductive decomposition, and a part of the solvent in the electrolytic solution is reductively decomposed on the negative electrode regardless of the kind of the negative electrode material, so that there were involved such problems that the movement of a lithium ion is disturbed due to deposition of decomposition products, generation of a gas, or expansion of the electrode, thereby worsening battery characteristics, such as cycle property, etc., especially in the case of using the lithium secondary battery at a high voltage; and that the battery is deformed due to expansion of the electrode. Furthermore, it is known that a lithium secondary battery using a lithium metal or an alloy thereof, or a metal elemental substance, such as tin, silicon, etc., or a metal oxide thereof as the negative electrode material may have a high initial battery capacity, but the battery capacity and the battery performance thereof, such as the cycle property, may be largely worsened because the micronized powdering of the material may be promoted during cycles, which brings about accelerated reductive decomposition of the nonaqueous solvent, as compared with the negative electrode formed of a carbon material, and the battery may be deformed due to expansion of the electrode.

Meanwhile, since a material capable of absorbing and releasing lithium, which is used as a positive electrode material, such as LiCoO₂, LiMn₂O₄, LiNiO₂, LiFePO₄, etc., stores and releases lithium and an electron at an electropositive voltage of 3.5 V or more on the lithium basis, it has a possibility that a lot of solvents are subjected to oxidative decomposition especially in the case of using the lithium secondary battery at a high voltage, and a part of the solvent in the electrolytic solution is oxidatively decomposed on the positive electrode regardless of the kind of the positive electrode material, so that there were involved such problems that the resistance is increased due to deposition of decomposition products; and that a gas is generated due to decomposition of the solvent, thereby expanding the battery.

Irrespective of the foregoing situation, the multifunctionality of electronic devices on which lithium secondary batteries are mounted is more and more advanced, and power consumption tends to increase. The capacity of the lithium secondary battery is thus being much increased, and the space volume for the nonaqueous electrolytic solution in the battery is decreased by increasing the density of the electrode, or reducing the useless space volume in the battery, or the like. In consequence, it is a situation that the battery performance in the case of using the battery at a high voltage is easily worsened due to even a bit of decomposition of the nonaqueous electrolytic solution.

PTL 1 discloses an electrolytic solution for lithium secondary battery including a sulfone compound having a structure in which an aryl group and a sulfonyl group are bonded together, such as benzenesulfonyl fluoride, and the like, and describes that electrochemical characteristics of the battery, especially the discharge characteristics at a high rate at a low temperature can be improved by decreasing the internal resistance of the battery.

PTL 2 discloses a nonaqueous electrolytic solution including a sulfone compound having a structure in which an alkyl group and a sulfonyl group are bonded together, such as methanesulfonyl fluoride, and a cyclic carbonate, and describes that when this electrolytic solution is used, a decrease of the capacity and the gas generation during continuous charging can be inhibited, and an excellent cycle property is exhibited.

PTL 3 discloses an electrolytic solution including a solvent containing a sulfone compound having a structure in which a fluorine group and a sulfonyl group are bonded together, such as trifluorovinylsulfonyl fluoride, and describes that in a battery provided with this electrolytic solution, since the decomposition reaction of the electrolytic solution is prevented, the cycle property can be improved.

In PTLs 1 to 3, though a vinylsulfonyl fluoride is suggested or described, it is not described in any working example.

PTL 1: JP-A 2002-359001

PTL 2: WO 2005/114773

PTL 3: JP-A 2009-54288

### SUMMARY OF INVENTION

### Technical Problem

Problems to be solved by the present invention are to provide a nonaqueous electrolytic solution capable of improving electrochemical characteristics in the case of using an energy storage device at a high voltage and further capable of not only improving a discharge capacity retention rate after a high-voltage cycle but also inhibiting gas generation, and also to provide an energy storage device using the same.

### Solution to Problem

The present inventors made extensive and intensive investigations regarding the performance of the nonaqueous electrolytic solutions of the aforementioned conventional technologies. As a result, according to the nonaqueous electrolytic solutions of the above-cited PTLs 1 to 3, though the low-temperature characteristics can be improved, the decrease of capacity and the gas generation during continuous charging can be inhibited, and the cycle property and the like can be improved, in the case of contemplating to achieve a more increase of the working voltage of the energy storage device in the future, it may not be said that the nonaqueous electrolytic solutions of PTLs 1 to 3 are thoroughly satisfactory. Above all, PTLs 1 to 3 do not disclose anything for a problem of inhibiting the gas generation following charge/discharge at all when an energy storage device is used at a high voltage.

Then, in order to solve the above-described problem, the present inventors made extensive and intensive investigations. As a result, it has been found that by using a nonaqueous solvent containing a cyclic carbonate and a linear carbonate in a specified proportion and adding a specified amount of vinylsulfonyl fluoride to a nonaqueous electrolytic solution, not only a discharge capacity retention rate after a cycle in the case of using an energy storage device at a high voltage can be improved, but also the gas generation can be inhibited, leading to accomplishment of the present invention.

Specifically, the present invention provides the following (1) and (2).

(1) A nonaqueous electrolytic solution having an electrolyte salt dissolved in a nonaqueous solvent, the nonaqueous solvent comprising a cyclic carbonate and a linear carbonate under the following condition 1 or 2, and the nonaqueous electrolytic solution comprising from 0.001 to 5% by mass of vinylsulfonyl fluoride.

Condition 1: The linear carbonate comprises both a symmetric linear carbonate and an asymmetric linear carbonate, and the proportion of the asymmetric linear carbonate occupying in the linear carbonate is from 51 to 95% by volume.

Condition 2: The cyclic carbonate comprises ethylene carbonate and propylene carbonate, and the linear carbonate comprises a symmetric linear carbonate.

(2) An energy storage device comprising a positive electrode, a negative electrode, and a nonaqueous electrolytic solution having an electrolyte salt dissolved in a nonaqueous solvent, the nonaqueous solvent comprising a cyclic carbonate and a linear carbonate under the following condition 1 or 2, and the nonaqueous electrolytic solution comprising from 0.001 to 5% by mass of vinylsulfonyl fluoride.

Condition 1: The linear carbonate comprises both a symmetric linear carbonate and an asymmetric linear carbonate, and the proportion of the asymmetric linear carbonate occupying in the linear carbonate is from 51 to 95% by volume.

Condition 2: The cyclic carbonate comprises ethylene carbonate and propylene carbonate, and the linear carbonate comprises a symmetric linear carbonate.

### Advantageous Effects of Invention

According to the present invention, it is possible to provide a nonaqueous electrolytic solution capable of improving the electrochemical characteristics in the case of using an energy storage device at a high voltage and further capable of not only improving a discharge capacity retention rate after a high-voltage cycle but also inhibiting the gas generation, and also to provide an energy storage device using the same, such as a lithium battery, etc.

### DESCRIPTION OF EMBODIMENTS

### [Nonaqueous Electrolytic Solution]

The nonaqueous electrolytic solution of the present invention is concerned with a nonaqueous electrolytic solution having an electrolyte salt dissolved in a nonaqueous solvent, the nonaqueous solvent comprising a cyclic carbonate and a linear carbonate under the following condition 1 or 2, and the nonaqueous electrolytic solution comprising from 0.001 to 5% by mass of vinylsulfonyl fluoride.

Condition 1: The linear carbonate comprises both a symmetric linear carbonate and an asymmetric linear carbonate, and the proportion of the asymmetric linear carbonate occupying in the linear carbonate is from 51 to 95% by volume.

Condition 2: The cyclic carbonate comprises ethylene carbonate and propylene carbonate, and the linear carbonate comprises a symmetric linear carbonate.

Although the reason why the nonaqueous electrolytic solution of the present invention is capable of significantly improving the electrochemical characteristics in the case of using an energy storage device at a high voltage is not clear, the following may be considered.

In view of the fact that a vinylsulfonyl fluoride represented by a chemical formula: CH₂═CH—SO₂F, which is used in the present invention, has a vinyl group, all of the three substituents of the vinyl group are hydrogen atoms, and the vinyl group is bonded directly to the SO₂ group, it may be considered that as compared with a compound in which the sulfone group has a phenyl group, an alkyl group, or a vinyl group totally substituted with fluorine atoms, and the like, the vinylsulfonyl fluoride has high reactivity and a firmer surface film is quickly formed on active points on both the positive electrode and the negative electrode, whereby not only the high-voltage cycle property can be improved, but also the gas generation due to decomposition of the solvent can be inhibited.

In addition, it may be considered that when the nonaqueous solvent including a cyclic carbonate and a linear carbonate in the aforementioned specified proportion is used, stability of the surface film on the electrode surface increases, and the cycle property in the case of using an energy storage device at a high voltage is improved.

In the nonaqueous electrolytic solution of the present invention, it is preferred that a content of vinylsulfonyl fluoride is from 0.001 to 5% by mass in the nonaqueous electrolytic solution. When the content is 5% by mass or less, there is less concern that a surface film is excessively formed on the electrode, thereby causing worsening of the cycle property in the case of using the battery at a high voltage, and when it is 0.001% by mass or more, a surface film is sufficiently formed, thereby increasing an effect for improving the cycle property in the case of using the battery at a high voltage. The content is preferably 0.01% by mass or more, and more preferably 0.1% by mass or more in the nonaqueous electrolytic solution. In addition, an upper limit thereof is preferably 4% by mass or less, more preferably 3% by mass or less, and still more preferably 2% by mass or less.

In the nonaqueous electrolytic solution of the present invention, by combining vinylsulfonyl fluoride with a nonaqueous solvent and an electrolyte salt as described below, a peculiar effect such that not only the discharge capacity retention rate after a cycle in the case of using the energy storage device at a high voltage may be improved, but also the gas generation may be inhibited is revealed.

### [Nonaqueous Solvent]

Examples of the nonaqueous solvent which is used for the nonaqueous electrolytic solution of the present invention include cyclic carbonates, linear esters, lactones, ethers, and amides; and it is preferred that both a cyclic carbonate and a linear ester are contained.

The term, linear ester, is used as a concept including a linear carbonate and a linear carboxylic acid ester.

As the cyclic carbonate, one or more selected from ethylene carbonate (EC), propylene carbonate (PC), 1,2-butylene carbonate, 2,3-butylene carbonate, a cyclic carbonate having a fluorine atom or an unsaturated bond, and the like are exemplified.

As the cyclic carbonate having a fluorine atom, one or more selected from 4-fluoro-1,3-dioxolan-2-one (FEC) and trans- or cis-4,5-difluoro-1,3-dioxolan-2-one (the both will be hereunder named generically as “DFEC”) are preferred.

As the cyclic carbonate having an unsaturated bond, such as a carbon-carbon double bond, a carbon-carbon triple bond, etc., vinylene carbonate (VC), vinyl ethylene carbonate (VEC), 4-ethynyl-1,3-dioxolan-2-one (EEC), and the like are exemplified; and one or more selected from vinylene carbonate (VC), vinyl ethylene carbonate (VEC), and 4-ethynyl-1,3-dioxolan-2-one (EEC) are preferred.

Use of at least one of the aforementioned cyclic carbonates having a fluorine atom or an unsaturated bond is preferred because the gas generation after a cycle in the case of using the energy storage device at a high voltage may be much more inhibited; and it is more preferred to include both the cyclic carbonate containing a fluorine atom and the cyclic carbonate having an unsaturated bond as described above.

A content of the aforementioned cyclic carbonate having an unsaturated bond is preferably 0.07% by volume or more, more preferably 0.2% by volume or more, and still more preferably 0.7% by volume or more relative to a total volume of the nonaqueous solvent; and when an upper limit thereof is preferably 7% by volume or less, more preferably 4% by volume or less, and still more preferably 2.5% by volume or less, stability of a surface film is increased, and the cycle property in the case of using the energy storage device at a high voltage is improved, and hence, such is preferred.

A content of the cyclic carbonate having a fluorine atom is preferably 0.07% by volume or more, more preferably 4% by volume or more, and still more preferably 7% by volume or more relative to a total volume of the nonaqueous solvent; and when an upper limit thereof is preferably 35% by volume or less, more preferably 25% by volume or less, and still more preferably 15% by volume or less, stability of a surface film is increased, and the cycle property in the case of using the energy storage device at a high voltage is improved, and hence, such is preferred.

In the case where the nonaqueous solvent includes both the cyclic carbonate having an unsaturated bond and the cyclic carbonate having a fluorine atom as described above, the proportion of the content of the cyclic carbonate having an unsaturated bond to the content of the cyclic carbonate having a fluorine atom is preferably 0.2% or more, more preferably 3% or more, and still more preferably 7% or more; and when an upper limit thereof is preferably 40% or less, more preferably 30% or less, and still more preferably 15% or less, stability of a surface film is increased, and the cycle property in the case of using the energy storage device at a high voltage is improved, and hence, such is especially preferred.

In addition, when the nonaqueous solvent includes ethylene carbonate and/or propylene carbonate, resistance of a surface film formed on an electrode becomes small, and hence, such is preferred. A content of ethylene carbonate and/or propylene carbonate is preferably 3% by volume or more, more preferably 5% by volume or more, and still more preferably 7% by volume or more relative to a total volume of the nonaqueous solvent; and an upper limit thereof is preferably 45% by volume or less, more preferably 35% by volume or less, and still more preferably 25% by volume or less.

These solvents may be used solely; in the case where a combination of two or more of the solvents is used, the electrochemical characteristics in the case of using the energy storage device at a high voltage are more improved, and hence, such is preferred; and use of a combination of three or more thereof is especially preferred.

As suitable combinations of these cyclic carbonates, EC and PC; EC and VC; PC and VC; VC and FEC; EC and FEC; PC and FEC; FEC and DFEC; EC and DFEC; PC and DFEC; VC and DFEC; VEC and DFEC; VC and EEC; EC and EEC; EC, PC and VC; EC, PC and FEC; EC, VC and FEC; EC, VC and VEC; EC, VC and EEC; EC, EEC and FEC; PC, VC and FEC; EC, VC and DFEC; PC, VC and DFEC; EC, PC, VC and FEC; EC, PC, VC and DFEC; and the like are preferred. Among the aforementioned combinations, combinations, such as EC and PC; EC and VC; EC and FEC; PC and FEC; EC, PC and VC; EC, PC and FEC; EC, VC and FEC; EC, VC and EEC; EC, EEC and FEC; PC, VC and FEC; EC, PC, VC and FEC; etc., are more preferred.

In addition, a cyclic carbonate containing EC or PC and a cyclic carbonate having a fluorine atom or an unsaturated bond is preferred; a cyclic carbonate containing EC or PC and a cyclic carbonate having a fluorine atom is more preferred; and a cyclic carbonate containing EC or PC, and FEC or DFEC is still more preferred.

As the linear ester, there are suitably exemplified one or more asymmetric linear carbonates selected from methyl ethyl carbonate (MEC), methyl propyl carbonate (MPC), methyl isopropyl carbonate (MIPC), methyl butyl carbonate, ethyl propyl carbonate, and the like; one or more symmetric linear carbonates selected from dimethyl carbonate (DMC), diethyl carbonate (DEC), dipropyl carbonate, dibutyl carbonate, and the like; and linear carboxylic acid esters, such as pivalic acid esters, such as methyl pivalate, ethyl pivalate, propyl pivalate, etc., methyl propionate, ethyl propionate, methyl acetate, ethyl acetate, n-propyl acetate, etc. In particular, when the asymmetric linear carbonate is included, the cycle property in the case of using the energy storage device at a high voltage is improved, and the gas generation amount tends to decrease, and hence, such is preferred.

These solvents may be used solely; and in the case of using a combination of two or more of the solvents, the cycle property in the case of using the energy storage device at a high voltage is improved, and the gas generation amount decreases, and hence, such is preferred.

Although a content of the linear ester is not particularly limited, it is preferred to use the linear ester in the range of from 60 to 90% by volume relative to a total volume of the nonaqueous solvent. When the content is 60% by volume or more, and preferably 65% by volume or more, an effect for decreasing the viscosity of the nonaqueous electrolytic solution is thoroughly obtained, whereas when it is 90% by volume or less, preferably 85% by volume or less, and still more preferably 80% by volume or less, an electroconductivity of the nonaqueous electrolytic solution thoroughly increases, whereby the electrochemical characteristics in the case of using the energy storage device at a high voltage are improved, and therefore, it is preferred that the content of the linear ester falls within the aforementioned range.

In addition, in the case of using a linear carbonate, it is preferred to use two or more kinds thereof. Furthermore, it is more preferred that both a symmetric linear carbonate and an asymmetric linear carbonate are included; it is still more preferred that the symmetric linear carbonate includes diethyl carbonate (DEC); it is still more preferred that the asymmetric linear carbonate includes methyl ethyl carbonate (MEC); and it is especially preferred that the linear carbonate includes both diethyl carbonate (DEC) and methyl ethyl carbonate (MEC).

It is preferred that a content of the asymmetric linear carbonate is greater than a content of the symmetric linear carbonate.

A proportion of the volume of the asymmetric linear carbonate occupying in the linear carbonate is preferably 51% by volume or more, more preferably 55% by volume or more, still more preferably 60% by volume or more, and yet still more preferably 65% by volume or more. An upper limit thereof is preferably 95% by volume or less, more preferably 90% by volume or less, still more preferably 85% by volume or less, and yet still more preferably 80% by volume or less.

The aforementioned case is preferred because the cycle property in the case of using the energy storage device at a high voltage is much more improved.

From the foregoing viewpoints, in the present invention, the nonaqueous solvent comprises a cyclic carbonate and a linear carbonate under the following condition 1 or 2.

Condition 1: The linear carbonate comprises both a symmetric linear carbonate and an asymmetric linear carbonate, and the proportion of the asymmetric linear carbonate occupying in the linear carbonate is from 51 to 95% by volume.

Condition 2: The cyclic carbonate comprises ethylene carbonate and propylene carbonate, and the linear carbonate comprises a symmetric linear carbonate.

Here, suitable examples of the cyclic carbonate and the linear carbonate (the symmetric linear carbonate and the asymmetric linear carbonate) are those as described above.

As for the proportion of the cyclic carbonate and the linear carbonate, from the viewpoint of improving the electrochemical characteristics in the case of using the energy storage device at a high voltage, a ratio of the cyclic carbonate to the linear carbonate (volume ratio) is preferably from 10/90 to 45/55, more preferably from 15/85 to 40/60, and especially preferably from 20/80 to 35/65.

Examples of other nonaqueous solvents which can be used in the present invention include lactones, such as γ-butyrolactone, γ-valerolactone, α-angelicalactone, etc.; cyclic ethers, such as tetrahydrofuran, 2-methyltetrahydrofuran, 1,3-dioxolane, 1,4-dioxane, etc.; linear ethers, such as 1,2-dimethoxyethane, 1,2-diethoxyethane, 1,2-dibutoxyethane, etc.; amides, such as dimethylformamide, etc.; and the like.

For the purpose of much more improving the electrochemical characteristics in the case of using the energy storage device at a high voltage, it is preferred to further add other additives in the nonaqueous electrolytic solution.

Specifically, examples of other additives include phosphoric acid esters, nitriles, triple bond-containing compounds, S═O bond-containing compounds, cyclic acid anhydrides, cyclic phosphazene compounds, cyclic acetals, aromatic compounds having a branched alkyl group, aromatic compounds, and the like.

Examples of the phosphoric acid ester include trimethyl phosphate, tributyl phosphate, trioctyl phosphate, and the like.

Examples of the nitrile include acetonitrile, propionitrile, succinonitrile, 2-ethylsuccinonitrile, glutaronitrile, 2-methylglutaronitrile, 3-methylglutaronitrile, adiponitrile, pimelonitrile, and the like.

Examples of the triple bond-containing compound include methyl 2-propynyl carbonate, 2-propynyl acetate, 2-propynyl formate, 2-propynyl methacrylate, 2-propynyl methanesulfonate, 2-propynyl vinylsulfonate, di(2-propynyl) oxalate, di(2-propynyl) glutarate, 2-butyne-1,4-diyl dimethanesulfonate, 2-butyne-1,4-diyl diformate, 2-propynyl 2-(diethoxyphosphoryl)acetate, 2-propynyl 2-((methanesulfonyl)oxy)propanoate, and the like.

Examples of the S═O bond-containing compound include sultone compounds, cyclic sulfite compounds, sulfonic acid ester compounds, and the like.

Examples of the sultone compound include 1,3-propanesultone, 1,3-butanesultone, 2,4-butanesultone, 1,4-butanesultone, 2,2-dioxide-1,2-oxathiolan-4-yl acetate, 5,5-dimethyl-1,2-oxathiolan-4-one 2,2-dioxide, and the like.

Examples of the cyclic sulfite compound include ethylene sulfite, hexahydrobenzo[1,3,2]dioxathiolane-2-oxide (also called 1,2-cyclohexanediol cyclic sulfite), 5-vinyl-hexahydro-1,3,2-benzodioxathiol-2-oxide, and the like.

Examples of the sulfonic acid ester compound include butane-2,3-diyl dimethanesulfonate, butane-1,4-diyl dimethanesulfonate, methylene methanedisulfonate, dimethyl methanedisulfonate, and the like.

Examples of the vinylsulfone compound include divinylsulfone, 1,2-bis(vinylsulfonynethane, bis(2-vinylsulfonylethyl) ether, and the like.

Examples of the acid anhydride include linear carboxylic acid anhydrides, such as acetic anhydride, propionic anhydride, etc., succinic anhydride, maleic anhydride, glutaric anhydride, itaconic anhydride, 3-sulfo-propionic anhydride, and the like.

Examples of the cyclic phosphazene compound include methoxypentafluorocyclotriphosphazene, ethoxypentafluorocyclotriphosphazene, phenoxypentafluorocyclotriphosphazene, ethoxyheptafluorocyclotetraphosphazene, and the like.

Examples of the diisocyanate compound include 1,4-diisocyanatobutane, 1,5-diisocyanatopentane, 1,6-diisocyanatohexane, 1,7-diisocyanatoheptane, and the like.

Examples of the cyclic acetal include 1,3-dioxolane, 1,3-dioxane, and the like.

Examples of the aromatic compound having a branched alkyl group include cyclohexylbenzene, fluorocyclohexylbenzene compounds (e.g., 1-fluoro-2-cyclohexylbenzene, 1-fluoro-3-cyclohexylbenzene, or 1-fluoro-4-cyclohexylbenzene), tert-butylbenzene, tert-amylbenzene, 1-fluoro-4-tert-butylbenzene, and the like.

Examples of the aromatic compound include biphenyl, terphenyl (o-, m-, p-form), diphenyl ether, fluorobenzene, difluorobenzene (o-, m-, p-form), anisole, 2,4-difluoroanisole, partial hydrides of terphenyl (e.g., 1,2-dicyclohexylbenzene, 2-phenylbicyclohexyl, 1,2-diphenylcyclohexane, or o-cyclohexylbiphenyl), and the like.

Above all, when one or more selected from the nitrile, the diisocyanate compound, and the cyclic acetal compound are included, the electrochemical characteristics in the case of using the energy storage device at a high voltage are much more improved, and hence, such is preferred.

Of the nitriles, one or more selected from succinonitrile, 2-ethylsuccinonitrile, glutaronitrile, 2-methylglutaronitrile, 3-methylglutaronitrile, adiponitrile, and pimelonitrile are more preferred.

Of the diisocyanate compounds, one or more selected from 1,5-diisocyanatopentane, 1,6-diisocyanatohexane, and 1,7-diisocyanatoheptane are more preferred.

Of the cyclic acetal compounds, 1,3-dioxane is preferred.

A content of the nitrile, the diisocyanate compound, and/or the cyclic acetal compound is preferably from 0.001 to 5% by mass in the nonaqueous electrolytic solution. When the content falls within this range, a surface film is thoroughly formed without becoming excessively thick, and an effect for improving the electrochemical characteristics in the case of using the energy storage device at a high voltage is increased. The content is more preferably 0.005% by mass or more, still more preferably 0.01% by mass or more, and especially preferably 0.03% by mass or more in the nonaqueous electrolytic solution; and an upper limit thereof is more preferably 3% by mass or less, still more preferably 2% by mass or less, and especially preferably 1.5% by mass or less.

In addition, above all, when the triple bond-containing compound is included, the electrochemical characteristics in the case of using the battery at a high voltage are much more improved, and hence, such is preferred. Of the triple bond-containing compounds, one or more selected from methyl 2-propynyl carbonate, 2-propynyl methanesulfonate, 2-propynyl vinylsulfonate, di(2-propynyl) oxalate, 2-butyne-1,4-diyl dimethanesulfonate, 2-propynyl 2-(diethoxyphosphoryl)acetate, and 2-propynyl 2-((methanesulfonyl)oxy)propanoate are more preferred. A content of the triple bond-containing compound is preferably from 0.001 to 5% by mass in the nonaqueous electrolytic solution. When the content falls within this range, a surface film is thoroughly formed without becoming excessively thick, and an effect for improving the electrochemical characteristics in the case of using the energy storage device at a high voltage is increased. The content is more preferably 0.005% by mass or more, still more preferably 0.01% by mass or more, and especially preferably 0.03% by mass or more in the nonaqueous electrolytic solution; and an upper limit thereof is more preferably 3% by mass or less, still more preferably 2% by mass or less, and especially preferably 1.5% by mass or less.

In addition, for the purpose of much more improving the electrochemical characteristics in the case of using the energy storage device at a high voltage, it is preferred that the nonaqueous electrolytic solution further includes one or more lithium salts selected from lithium salts having an oxalic acid skeleton, lithium salts having a phosphoric acid skeleton, and lithium salts having a sulfonic acid skeleton.

As specific examples of the lithium salt, one or more selected from at least one lithium salts having an oxalic acid skeleton selected from the following structural formulae 1 to 4, lithium salts having a phosphoric acid skeleton, such as LiPO₂F₂, etc., and one or more lithium salts having a sulfonic acid skeletons selected from the following structural formulae 5 and 6 and FSO₃Li are suitably exemplified; it is more preferred to include one or more lithium salt having a sulfonic acid skeletons selected from the following structural formulae 5 and 6; and it is still more preferred to include a combination of two or more selected from the following structural formulae 1 to 6, LiPO₂F₂, and FSO₃Li.

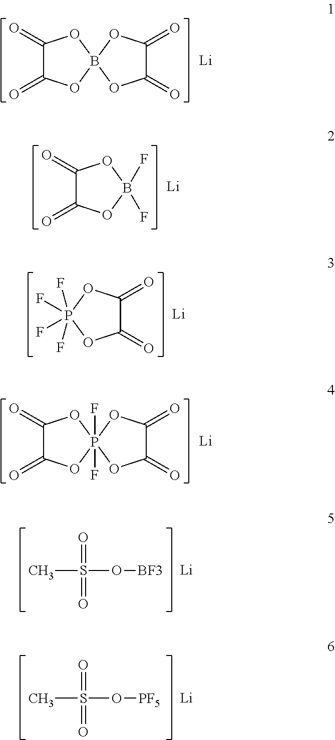

A total content of one or more lithium salts selected from the structural formulae 1 to 6, LiPO₂F₂, and FSO₃Li is preferably from 0.001 to 10% by mass in the nonaqueous electrolytic solution. When the content is 10% by mass or less, there is less concern that a surface film is excessively formed on the electrode, thereby causing worsening of the cycle property, and when it is 0.001% by mass or more, a surface film is sufficiently formed, thereby increasing an effect for improving the characteristics in the case of using the battery at a high voltage. The content is preferably 0.05% by mass or more, more preferably 0.1% by mass or more, and still more preferably 0.3% by mass or more in the nonaqueous electrolytic solution; and an upper limit thereof is preferably 5% by mass or less, more preferably 3% by mass or less, and still more preferably 2% by mass or less.

### [Electrolyte Salt]

As the electrolyte salt which is used in the present invention, there are suitably exemplified the following lithium salts.

### (Lithium Salt)

As the lithium salt, there are suitably exemplified inorganic lithium salts, such as LiPF₆, Li₂PO₃F, LiBF₄, LiClO₄, etc.; linear fluoroalkyl group-containing lithium salts, such as LiN(SO₂F)₂, LiN(SO₂CF₃)₂, LiN(SO₂C₂F₅)₂, LiCF₃SO₃, LiC(SO₂CF₃)₃, LiPF₄(CF₃)₂, LiPF₃(C₂F₅)₃, LiPF₃(CF₃)₃, LiPF₃(iso-C₃F₇)₃, LiPF₅(iso-C₃F₇), etc.; and cyclic fluoroalkylene chain-containing lithium salts, such as (CF₂)₂(SO₂)₂NLi, (CF₂)₃(SO₂)₂NLi, etc.; and one or more of these may be used in admixture.

Of those, one or more selected from LiPF₆, Li₂PO₃F, LiBF₄, LiN(SO₂CF₃)₂, LiN(SO₂C₂F₅)₂, and LiN(SO₂F)₂ are preferred; one or more selected from LiPF₆, LiBF₄, LiN(SO₂CF₃)₂, and LiN(SO₂F)₂ are more preferred; and it is especially preferred to use LiPF₆.

In general, a concentration of the lithium salt is preferably 0.3 M or more, more preferably 0.7 M or more, and still more preferably 1.1 M or more relative to the aforementioned nonaqueous solvent. In addition, an upper limit thereof is preferably 2.5 M or less, more preferably 2.0 M or less, and still more preferably 1.6 M or less.

In addition, as a suitable combination of these lithium salts, the case where the nonaqueous electrolytic solution includes LiPF₆ and further includes at least one lithium salt selected from LiBF₄, LiN(SO₂CF₃)₂, and LiN(SO₂F)₂ is preferred. When the proportion of the lithium salt other than LiPF₆ occupying in the nonaqueous solvent is 0.001 M or more, an effect for improving the electrochemical characteristics in the case of using the battery at a high voltage is easily exhibited, whereas when it is 0.005 M or less, there is less concern that an effect for improving the electrochemical characteristics in the case of using the battery at a high voltage is worsened, and hence, such is preferred. The content is preferably 0.01 M or more, especially preferably 0.03 M or more, and most preferably 0.04 M or more. An upper limit thereof is preferably 0.4 M or less, and especially preferably 0.2 M or less.

### [Production of Nonaqueous Electrolytic Solution]

The nonaqueous electrolytic solution of the present invention may be, for example, obtained by mixing the aforementioned nonaqueous solvent and adding vinylsulfonyl fluoride to the aforementioned electrolyte salt and the nonaqueous electrolytic solution.

At this time, the nonaqueous solvent used and the compounds added to the nonaqueous electrolytic solution are preferably purified previously to reduce as much as possible the content of impurities, in such an extent that the productivity is not extremely deteriorated.

The nonaqueous electrolytic solution of the present invention may be used in first and second energy storage devices shown below, in which the nonaqueous electrolyte may be used not only in the form of a liquid but also in the form of a gel. Furthermore, the nonaqueous electrolytic solution of the present invention may also be used for a solid polymer electrolyte. Among these, the nonaqueous electrolytic solution is preferably used in the first energy storage device using a lithium salt as the electrolyte salt (i.e., for a lithium battery) or in the second energy storage device (i.e., for a lithium ion capacitor), more preferably used in a lithium battery, and most suitably used in a lithium secondary battery.

### [First Energy Storage Device (Lithium Battery)]

The lithium battery of the present invention is a generic name for a lithium primary battery and a lithium secondary battery. In addition, in the present specification, the term, lithium secondary battery, is used as a concept that includes a so-called lithium ion secondary battery. The lithium battery of the present invention includes a positive electrode, a negative electrode, and the aforementioned nonaqueous electrolytic solution having an electrolyte salt dissolved in a nonaqueous solvent. Other constitutional members used than the nonaqueous electrolytic solution, such as the positive electrode, the negative electrode, etc., are not particularly limited.

For example, as the positive electrode active material for lithium secondary batteries, usable is a complex metal oxide of lithium and one or more selected from cobalt, manganese, and nickel. These positive electrode active materials may be used solely or in combination of two or more kinds thereof.

As the lithium complex metal oxides, for example, one or more selected from LiCoO₂, LiMn₂O₄, LiNiO₂, LiCo₁₋ₓNi₃O₂ (0.01<x<1), LiCo_{1/3}Ni_{1/3}Mn_{1/3}O₂, LiNi_{1/2}Mn_{3/2}O₄, and LiCo_{0.98}Mg_{0.02}O₂ are preferably exemplified. In addition, these materials may be used as a combination, such as a combination of LiCoO₂ and LiMn₂O₄, a combination of LiCoO₂ and LiNiO₂, and a combination of LiMn₂O₄ and LiNiO₂.

In addition, for improving the safety on overcharging and the cycle property, and for enabling the use at a charge potential of 4.3 V or more, a part of the lithium complex metal oxide may be substituted with other elements. For example, a part of cobalt, manganese, or nickel may be substituted with at least one or more elements selected from Sn, Mg, Fe, Ti, Al, Zr, Cr, V, Ga, Zn, Cu, Bi, Mo, La, and the like; or a part of O may be substituted with S or F; or the oxide may be coated with a compound containing any of such other elements.

Of those, preferred are lithium complex metal oxides, such as LiCoO₂, LiMn₂O₄, and LiNiO₂, which may be used at a charge potential of the positive electrode in a fully-charged state of 4.3 V or more based on Li; and more preferred are lithium complex metal oxides, such as LiCo₁₋ₓMₓO₂ (wherein M is at least one element selected from Sn, Mg, Fe, Ti, Al, Zr, Cr, V, Ga, Zn, and Cu; and 0.001≦x≦0.05), LiCo_{1/3}Ni_{1/3}Mn_{1/3}O₂, LiNi_{1/2}Mn_{3/2}O₄, and a solid solution of Li₂MnO₃ and LiMO₂ (wherein M is a transition metal, such as Co, Ni, Mn, Fe, etc.), that may be used at 4.4 V or more. The use of the lithium complex metal oxide capable of acting at a high charging voltage may easily worsen the electrochemical characteristics particularly in the case of using the battery at a high voltage due to the reaction with the electrolytic solution on charging, but in the lithium secondary battery according to the present invention, the electrochemical characteristics may be prevented from worsening.

Furthermore, a lithium-containing olivine-type phosphate may also be used as the positive electrode active material. Especially preferred are lithium-containing olivine-type phosphates containing one or more selected from iron, cobalt, nickel, and manganese. Specific examples thereof include LiFePO₄, LiCoPO₄, LiNiPO₄, LiMnPO₄, and the like.

These lithium-containing olivine-type phosphates may be partly substituted with any other element; and for example, a part of iron, cobalt, nickel, or manganese therein may be substituted with one or more elements selected from Co, Mn, Ni, Mg, Al, B, Ti, V, Nb, Cu, Zn, Mo, Ca, Sr, W, Zr, and the like; or the phosphates may be coated with a compound containing any of these other elements or with a carbon material. Among these, in the case of using a lithium-containing olivine-type phosphate containing at least Co, Ni, or Mn, such as LiCoPO₄, LiNiPO₄, LiMnPO₄, etc., the battery voltage becomes a higher potential, and the effects of the invention of the present application are easily revealed, and hence, such is preferred.

In addition, the lithium-containing olivine-type phosphate may be used, for example, in admixture with the aforementioned positive electrode active material.

In addition, for the positive electrode for lithium primary batteries, there are suitably exemplified oxides or chalcogen compounds of one or more metal elements selected from CuO, Cu₂O, Ag₂O, Ag₂CrO₄, CuS, CuSO₄, TiO₂, TiS₂, SiO₂, SnO, V₂O₅, V₆O₁₂, VOₓ, Nb₂O₅, Bi₂O₃, Bi₂Pb₂O₅, Sb₂O₃, CrO₃, Cr₂O₃, MoO₃, WO₃, SeO₂, MnO₂, Mn₂O₃, Fe₂O₃, FeO, Fe₃O₄, Ni₂O₃, NiO, CoO₃, CoO, etc.; sulfur compounds, such as SO₂, SOCl₂, etc.; and carbon fluorides (graphite fluoride) represented by a general formula (CFₓ)ₙ. Above all, MnO₂, V₂O₅, graphite fluoride, and the like are preferred.

An electroconductive agent of the positive electrode is not particularly limited so long as it is an electron-conductive material that does not undergo a chemical change. Examples thereof include graphites, such as natural graphite (e.g., flaky graphite, etc.), artificial graphite, etc.; carbon blacks, such as acetylene black, Ketjen black, channel black, furnace black, lamp black, thermal black, etc.; and the like. In addition, graphite and carbon black may be properly mixed and used. An addition amount of the electroconductive agent to the positive electrode mixture is preferably from 1 to 10% by mass, and especially preferably from 2 to 5% by mass.

The positive electrode may be produced by mixing the aforementioned positive electrode active material with an electroconductive agent, such as acetylene black, carbon black, etc., and a binder, such as polytetrafluoroethylene (PTFE), polyvinylidene fluoride (PVDF), a copolymer of styrene and butadiene (SBR), a copolymer of acrylonitrile and butadiene (NBR), carboxymethyl cellulose (CMC), an ethylene-propylene-diene terpolymer, etc., and adding a high-boiling point solvent, such as 1-methyl-2-pyrrolidone, etc., thereto, followed by kneading to prepare a positive electrode mixture, applying this positive electrode mixture onto a collector, such as an aluminum foil, a stainless steel-made lath plate, etc., and drying and shaping the resultant under pressure, followed by a heat treatment in vacuum at a temperature of from about 50° C. to 250° C. for about 2 hours.

A density of a portion of the positive electrode except for the collector is generally 1.5 g/cm³ or more, and for the purpose of further increasing the capacity of the battery, the density is preferably 2 g/cm³ or more, more preferably 3 g/cm³ or more, and still more preferably 3.6 g/cm³ or more. An upper limit thereof is preferably 4 g/cm³ or less.

As the negative electrode active material for lithium secondary batteries, one or more selected from a lithium metal, lithium alloys, carbon materials capable of absorbing and releasing lithium [e.g., graphitizable carbon, non-graphitizable carbon having a spacing of the (002) plane of 0.37 nm or more, graphite having a spacing of the (002) plane of 0.34 nm or less, etc.], tin (elemental substance), tin compounds, silicon (elemental substance), silicon compounds, and lithium titanate compounds, such as Li₄Ti₅O₁₂, etc., may be used in combination.

Of those, in absorbing and releasing ability of a lithium ion, it is more preferred to use a high-crystalline carbon material, such as artificial graphite, natural graphite, etc.; and it is especially preferred to use a carbon material having a graphite-type crystal structure in which a lattice (002) spacing (d₀₀₂) is 0.340 nm (nanometers) or less, and especially from 0.335 to 0.337 nm.

By using an artificial graphite particle having a bulky structure in which plural flat graphite fine particles are mutually gathered or bound in non-parallel, or a graphite particle prepared by, for example, subjecting a flaky natural graphite particle to a spheroidizing treatment by repeatedly giving a mechanical action, such as compression force, frictional force, shear force, etc., when a ratio [I(110)/I(004)] of a peak intensity I(110) of the (110) plane to a peak intensity I(004) of the (004) plane of the graphite crystal, which is obtained from the X-ray diffraction measurement of a negative electrode sheet at the time of shaping under pressure of a portion of the negative electrode except for the collector in a density of 1.5 g/cm³ or more, is 0.01 or more, the electrochemical characteristics in a much broader temperature range are improved, and hence, such is preferable; and the peak intensity ratio [I(110)/I(004)] is more preferably 0.05 or more, and still more preferably 0.1 or more. In addition, when excessively treated, there may be the case where the crystallinity is worsened, and the discharge capacity of the battery is worsened, and therefore, an upper limit thereof is preferably 0.5 or less, and more preferably 0.3 or less.

In addition, when the high-crystalline carbon material (core material) is coated with a carbon material that is more low-crystalline than the core material, the electrochemical characteristics in the case of using the battery at a high voltage become much more favorable, and hence, such is preferable. The crystallinity of the carbon material of the coating may be confirmed by TEM.

When the high-crystalline carbon material is used, there is a tendency that it reacts with the nonaqueous electrolytic solution on charging, thereby worsening the electrochemical characteristics at low temperatures or high temperatures due to an increase of the interfacial resistance; however, in the lithium secondary battery according to the present invention, the electrochemical characteristics in the case of using the battery at a high voltage become favorable.

In addition, as the metal compound capable of absorbing and releasing lithium, serving as a negative electrode active material, there are preferably exemplified compounds containing at least one metal element, such as Si, Ge, Sn, Pb, P, Sb, Bi, Al, Ga, In, Ti, Mn, Fe, Co, Ni, Cu, Zn, Ag, Mg, Sr, Ba, etc. The metal compound may be used in any form including an elemental substance, an alloy, an oxide, a nitride, a sulfide, a boride, an alloy with lithium, and the like, and any of an elemental substance, an alloy, an oxide, and an alloy with lithium is preferred because the battery capacity may be increased thereby. Above all, more preferred are those containing at least one element selected from Si, Ge, and Sn, and especially preferred are those containing at least one element selected from Si and Sn, as capable of increasing the battery capacity.

In the case of mixing the metal compound capable of absorbing and releasing lithium with the carbon material and using the mixture as the negative electrode active material for the negative electrode, as for a ratio of the metal compound capable of absorbing and releasing lithium and the carbon material, from the viewpoint of a cycle improvement on the basis of an effect for improving an electron conductivity due to the mixing with the carbon material, an amount of the carbon material is preferably 10% by mass or more, and more preferably 30% by mass or more relative to a total mass of the metal compound capable of absorbing and releasing lithium in the negative electrode mixture. In addition, when the ratio of the carbon material with which the metal compound capable of absorbing and releasing lithium is mixed is too large, there is a concern that the amount of the metal compound capable of absorbing and releasing lithium in the negative electrode mixture is decreased, whereby an effect for increasing the battery capacity becomes small, and therefore, the amount of the carbon material is preferably 98% by mass or less, and more preferably 90% by mass or less relative to a total mass of the metal compound capable of absorbing and releasing lithium. In the case of using a combination of the nonaqueous electrolytic solution containing vinylsulfonyl fluoride of the invention of the present application and the aforementioned negative electrode using a mixture of the aforementioned metal compound capable of absorbing and releasing lithium as the negative electrode active material and the carbon material, it may be considered that in view of the fact that the vinylsulfonyl fluoride acts on both the metal compound and the carbon material, the electrical contact of the metal compound in which a volume change following absorption and release of lithium is generally large, with the carbon material is reinforced, whereby the cycle property is much more improved.

The negative electrode may be formed in such a manner that the same electroconductive agent, binder, and high-boiling point solvent as in the formation of the aforementioned positive electrode are used and kneaded to provide a negative electrode mixture, and the negative electrode mixture is then applied onto a collector, such as a copper foil, etc., dried, shaped under pressure, and then heat-treated in vacuum at a temperature of from about 50° C. to 250° C. for about 2 hours.

A density of the portion of the negative electrode except for the collector is generally 1.1 g/cm³ or more, and for further increasing the battery capacity, the density is preferably 1.5 g/cm³ or more, and especially preferably 1.7 g/cm³ or more. An upper limit thereof is preferably 2 g/cm³ or less.

In addition, examples of the negative electrode active material for lithium primary batteries include a lithium metal and a lithium alloy.

The structure of the lithium battery is not particularly limited, and may be a coin-type battery, a cylinder-type battery, a prismatic battery, a laminate-type battery, or the like, each having a single-layered or multi-layered separator.

Although the separator for the battery is not particularly limited, a single-layered or laminated micro-porous film of a polyolefin, such as polypropylene, polyethylene, etc., as well as a woven fabric, a nonwoven fabric, or the like may be used.

The lithium secondary battery in the present invention has excellent electrochemical characteristics even in the case where the final charging voltage of the positive electrode against the lithium metal is 4.2 V or more, and particularly 4.3 V or more, and furthermore, the characteristics thereof are still favorable even at 4.4 V or more. Although a current value is not particularly limited, in general, the battery is used within the range of from 0.1 to 30 C. In addition, the lithium battery in the present invention may be charged and discharged at from −40 to 100° C., and preferably from −10 to 80° C.

In the present invention, as a countermeasure against an increase in the internal pressure of the lithium battery, such a method may be employed that a safety valve is provided in the battery cap, and a cutout is provided in the battery component, such as a battery can, a gasket, etc. In addition, as a safety countermeasure for preventing overcharging, a current cut-off mechanism capable of detecting an internal pressure of the battery to cut off the current may be provided in a battery cap.

### [Second Energy Storage Device (Lithium Ion Capacitor)]

The second energy storage device is an energy storage device that stores energy by utilizing intercalation of a lithium ion into a carbon material, such as graphite, etc., as the negative electrode. This energy storage device is called a lithium ion capacitor (LIC). Examples of the positive electrode include one utilizing an electric double layer between an active carbon electrode and an electrolytic solution, one utilizing a doping/dedoping reaction of a n-conjugated polymer electrode, and the like. The electrolytic solution contains at least a lithium salt, such as LiPF₆, etc.

The nonaqueous electrolytic solution of the present invention is capable of improving charging and discharging properties of a lithium ion capacitor which is used at a high voltage.

### EXAMPLES

### Examples 1 to 15 and Comparative Examples 1 to 9

### Production of Lithium Ion Secondary Battery

94% by mass of LiN_{1/3}Mn_{1/3}Co_{1/3}O₂ and 3% by mass of acetylene black (electroconductive agent) were mixed and then added to and mixed with a solution which had been prepared by dissolving 3% by mass of polyvinylidene fluoride (binder) in 1-methyl-2-pyrrolidone in advance, thereby preparing a positive electrode mixture paste. This positive electrode mixture paste was applied onto one surface of an aluminum foil (collector), dried, and treated under pressure, followed by cutting into a predetermined size, thereby producing a belt-like positive electrode sheet. A density of a portion of the positive electrode except for the collector was 3.6 g/cm³. In addition, 10% by mass of silicon (elemental substance), 80% by mass of artificial graphite (d₀₀₂=0.335 nm, negative electrode active material), and 5% by mass of acetylene black (electroconductive agent) were mixed and then added to and mixed with a solution which had been prepared by dissolving 5% by mass of polyvinylidene fluoride (binder) in 1-methyl-2-pyrrolidone in advance, thereby preparing a negative electrode mixture paste. This negative electrode mixture paste was applied onto one surface of a copper foil (collector), dried, and treated under pressure, followed by cutting into a predetermined size, thereby producing a negative electrode sheet. A density of a portion of the negative electrode except for the collector was 1.5 g/cm³. In addition, this electrode sheet was used and analyzed by means of X-ray diffraction, and as a result, a ratio [I(110)/I(004)] of a peak intensity I(110) of the (110) plane to a peak intensity I(004) of the (004) plane of the graphite crystal was found to be 0.1.

The above-obtained positive electrode sheet, a micro-porous polyethylene film-made separator, and the above-obtained negative electrode sheet were laminated in this order, and a nonaqueous electrolytic solution having any of compositions shown in Tables 1 and 2 was added thereto, thereby producing a laminate-type battery.

### [Evaluation of High-Voltage Cycle Property]

In a thermostatic chamber at 45° C., the battery produced by the aforementioned method was treated by repeating a cycle of charging up to a final voltage of 4.4 V with a constant current of 1 C and under a constant voltage for 3 hours and subsequently discharging down to a discharging voltage of 3.0 V with a constant current of 1 C, until it reached 100 cycles. Then, a discharge capacity retention rate was determined according to the following equation.

Discharge capacity retention rate (%)=(Discharge capacity after 100th cycle)/(Discharge capacity after 1st cycle)×100

[Evaluation of Gas Generation Amount after 100 Cycles]

A gas generation amount after 100 cycles was measured by the Archimedean method. As for the gas generation amount, a relative gas generation amount was examined on the basis of defining the gas generation amount of Comparative Example 1 as 100%.

In addition, the production condition and battery characteristics of each of the batteries are shown in Tables 1 and 2.

TABLE 1

| | | Sulfonyl compound | | | |
|---|---|---|---|---|---|
| | | | Addition | | |
| | | | amount | | |
| | | | (content in | Discharge | |
| | Composition of electrolyte salt | | nonaqueous | capacity | Gas |
| | Composition of nonaqueous | | electrolytic | retention | generation |
| | electrolytic solution | | solution) | rate | amount |
| | (volume ratio of solvent) | Kind | (% by mass) | (%) | (%) |
| Example 1 | 1.2M LiPF₆ | Vinylsulfonyl fluoride | 1 | 77 | 76 |
| | EC/MEC/DEC | | | | |
| | (30/50/20) | | | | |
| Example 2 | 1.2M LiPF₆ | | 0.05 | 79 | 74 |
| | EC/FEC/MEC/DEC | | | | |
| | (25/5/50/20) | | | | |
| Example 3 | 1.2M LiPF₆ | | 1 | 82 | 65 |
| | EC/FEC/MEC/DEC | | | | |
| | (25/5/50/20) | | | | |
| Example 4 | 1.2M LiPF₆ | | 3 | 80 | 60 |
| | EC/FEC/MEC/DEC | | | | |
| | (25/5/50/20) | | | | |
| Example 5 | 1.2M LiPF₆ | | 1 | 83 | 67 |
| | EC/FEC/PC/MEC/DEC | | | | |
| | (10/15/5/50/20) | | | | |
| Example 6 | 1.2M LiPF₆ | | 1 | 84 | 64 |
| | EC/FEC/VC/MEC/DEC | | | | |
| | (25/4/1/50/20) | | | | |
| Example 7 | 1.2M LiPF₆ | | 1 | 86 | 65 |
| | EC/FEC/EEC/MEC/DEC | | | | |
| | (24/5/1/50/20) | | | | |
| Example 8 | 1.2M LiPF₆ | | 1 | 85 | 63 |
| | EC/FEC/VC/PC/MEC/DEC | | | | |
| | (25/3/1/1/55/15) | | | | |
| Comparative | 1.2M LiPF₆ | — | — | 56 | 100 |
| Example 1 | EC/FEC/MEC/DEC | | | | |
| | (25/5/50/20) | | | | |
| Comparative | 1M LiPF₆ | Benzenesulfonyl | 1 | 62 | 97 |
| Example 2 | EC/DMC | fluoride | | | |
| | (1/1) | | | | |
| Comparative | 1.2M LiPF₆ | Benzenesulfonyl | 1 | 64 | 95 |
| Example 3 | EC/FEC/MEC/DEC | fluoride | | | |
| | (25/5/50/20) | | | | |
| Comparative | 1M LiPF₆ | Methanesulfonyl | 1 | 65 | 90 |
| Example 4 | EC/MEC/DMC | fluoride | | | |
| | (2/4/4) | | | | |
| Comparative | 1.2M LiPF₆ | Methanesulfonyl | 1 | 67 | 88 |
| Example 5 | EC/FEC/MEC/DEC | fluoride | | | |
| | (25/5/50/20) | | | | |
| Comparative | 1.2M LiPF₆ | 2-Propen-1-yl fluoride | 1 | 71 | 83 |
| Example 6 | EC/FEC/MEC/DEC | | | | |
| | (25/5/50/20) | | | | |
| Comparative | 1.2M LiPF₆ | 1-Propen-1-yl | 1 | 70 | 85 |
| Example 7 | EC/FEC/MEC/DEC | sulfonyl fluoride | | | |
| | (25/5/50/20) | | | | |
| Comparative | 1M LiPF₆ | 1,2,2-Trifluorovinyl- | 1 | 70 | 92 |
| Example 8 | EC/DEC | sulfonyl fluoride | | | |
| | (3/7) | | | | |
| Comparative | 1.2M LiPF₆ | 1,2,2-Trifluorovinyl- | 1 | 73 | 89 |
| Example 9 | EC/FEC/MEC/DEC | sulfonyl fluoride | | | |
| | (25/5/50/20) | | | | |

TABLE 2

| | | Sulfonyl compound | | Other compound | | | |
|---|---|---|---|---|---|---|---|
| | | | Addition | | Addition | | |
| | Composition of | | amount | | amount | | |
| | electrolyte salt | | (content in | | (content in | Discharge | |
| | Composition of | | nonaqueous | | nonaqueous | capacity | Gas |
| | nonaqueous | | electrolytic | | electrolytic | retention | generation |
| | electrolytic solution | | solution) | | solution) | rate | amount |
| | (volume ratio of solvent) | Kind | (% by mass) | Kind | (% by mass) | (%) | (%) |
| Example 9 | 1.2M LiPF₆ | Vinylsulfonyl | 1 | Adiponitrile + | 0.5 + 0.5 | 85 | 60 |
| | EC/FEC/MEC/DEC | fluoride | | 2-Methylglutaronitrile | | | |
| | (25/5/50/20) | | | | | | |
| Example 10 | 1.2M LiPF₆ | | 1 | 1,6-Diisocyanatohexane | 1 | 88 | 57 |
| | EC/FEC/MEC/DEC | | | | | | |
| | (25/5/50/20) | | | | | | |
| Example 11 | 1.2M LiPF₆ | | 1 | 1,3-Dioxane | 0.5 | 86 | 52 |
| | EC/FEC/MEC/DEC | | | | | | |
| | (25/5/50/20) | | | | | | |
| Example 12 | 1.2M LiPF₆ | | 1 | 2-Propynyl | 0.5 | 90 | 56 |
| | EC/FEC/MEC/DEC | | | 2-((methanesulfonyl)oxy)- | | | |
| | (25/5/50/20) | | | propanoate | | | |
| Example 13 | 1.2M LiPF₆ | | 1 | FSO₃Li | 0.2 | 86 | 61 |
| | EC/FEC/MEC/DEC | | | | | | |
| | (25/5/50/20) | | | | | | |
| Example 14 | 1.2M LiPF₆ EC/FEC/MEC/DEC (25/5/50/20) | | 1 | LiPO₂F₂ + 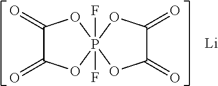 | 0.1 + 0.1 | 88 | 58 |
| Example 15 | 1.2M LiPF₆ EC/FEC/MEC/DEC (25/5/50/20) | | 1 | 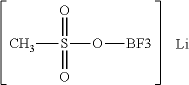 | 0.5 | 87 | 59 |

From Tables 1 and 2, all of the lithium secondary batteries of Examples 1 to 15, in which the nonaqueous solvent includes the cyclic carbonate and the linear carbonate under the condition 1 or 2 according to claim 1 in the nonaqueous electrolytic solution of the invention of the present application, improve the high-voltage cycle property and also inhibit the gas generation amount, as compared with the lithium secondary batteries of Comparative Example 1 which is the case of not including vinylsulfonyl fluoride and Comparative Examples 2 to 9 which are the case of including other sulfonyl compound than vinylsulfonyl fluoride.

In the light of the above, it has become clear that the effects brought in the case of using the energy storage device at a high voltage according to the present invention are peculiar effects brought in the case where the nonaqueous electrolytic solution includes a cyclic carbonate, a symmetric linear carbonate, and an asymmetric linear carbonate and also includes from 0.001 to 5% by mass of vinylsulfonyl fluoride.

Comparative Example 2 is corresponding to Example 15 of Table 1 of JP-A 2002-359001; however, since the asymmetric linear carbonate and the fluorine atom-containing cyclic carbonate are not contained, the results inferior to those in Comparative Example 3 are revealed.

Comparative Example 4 is corresponding to Example 1b-2 of Table 4 of WO 2005/114773; however, since the fluorine-containing cyclic carbonate is not contained, the results inferior to those in Comparative Example 5 are revealed.

Comparative Example 8 is corresponding to Example 1-5 of Table 1 of JP-A 2009-54288; however, since the asymmetric linear carbonate and the fluorine atom-containing cyclic carbonate are not contained, the results inferior to those in Comparative Example 9 are revealed.

### Examples 16 and 17 and Comparative Example 10

A positive electrode sheet was produced by using LiNi_{1/2}Mn_{3/2}O₄ (positive electrode active material) in place of the positive electrode active material used in Example 1 and Comparative Example 1. 94% by mass of LiNi_{1/2}Mn_{3/2}O₄ coated with amorphous carbon and 3% by mass of acetylene black (electroconductive agent) were mixed and then added to and mixed with a solution which had been prepared by dissolving 3% by mass of polyvinylidene fluoride (binder) in 1-methyl-2-pyrrolidone in advance, thereby preparing a positive electrode mixture paste. A laminate-type battery was produced and subjected to battery evaluation in the same manner as in Example 1 and Comparative Example 1, except that this positive electrode mixture paste was applied onto one surface of an aluminum foil (collector), dried, and treated under pressure, followed by cutting into a predetermined size, thereby producing a positive electrode sheet; and that in evaluating the battery, the final charging voltage and the final discharging voltage were set to 4.9 V and 2.7 V, respectively. The results are shown in Table 3.

TABLE 3

| | | Sulfonyl compound | | Other compound | | | |
|---|---|---|---|---|---|---|---|
| | | | Addition amount | | Addition amount | | |
| | | | (content in | | (content in | | |
| | Composition of electrolyte salt | | nonaqueous | | nonaqueous | | Gas |
| | Composition of nonaqueous | | electrolytic | | electrolytic | Discharge capacity | generation |
| | electrolytic solution | | solution) | | solution) | retention rate | amount |
| | (volume ratio of solvent) | Kind | (% by mass) | Kind | (% by mass) | (%) | (%) |
| Example 16 | 1.2M LiPF₆ | Vinylsulfonyl | 1 | — | — | 75 | 81 |
| | EC/FEC/MEC/DEC | fluoride | | | | | |
| | (25/5/50/20) | | | | | | |
| Example 17 | 1.2M LiPF₆ | | 1 | LiPO₂F₂ | 0.2 | 81 | 75 |
| | EC/FEC/MEC/DEC | | | | | | |
| | (25/5/50/20) | | | | | | |
| Comparative | 1.2M LiPF₆ | — | — | — | — | 53 | 100 |
| Example 10 | EC/FEC/MEC/DEC | | | | | | |
| | (25/5/50/20) | | | | | | |

### Examples 18 and 19 and Comparative Example 11

A negative electrode sheet was produced by using lithium titanate Li₄Ti₅O₁₂ (negative electrode active material) in place of the negative electrode active material used in Example 1 and Comparative Example 1. 80% by mass of lithium titanate Li₄Ti₅O₁₂ and 15% by mass of acetylene black (electroconductive agent) were mixed and then added to and mixed with a solution which had been prepared by dissolving 5% by mass of polyvinylidene fluoride (binder) in 1-methyl-2-pyrrolidone in advance, thereby preparing a negative electrode mixture paste. A laminate-type battery was produced and subjected to battery evaluation in the same manner as in Example 1 and Comparative Example 1, except that this negative electrode mixture paste was applied onto one surface of a copper foil (collector), dried, and treated under pressure, followed by cutting into a predetermined size, thereby producing a negative electrode sheet; and that in evaluating the battery, the final charging voltage and the final discharging voltage were set to 2.8 V and 1.2 V, respectively. The results are shown in Table 4.

TABLE 4

| | | Sulfonyl compound | | Other compound | | | |
|---|---|---|---|---|---|---|---|
| | | | Addition | | Addition | | |
| | Composition of | | amount | | amount | | |
| | electrolyte salt | | (content in | | (content in | Discharge | |
| | Composition of | | nonaqueous | | nonaqueous | capacity | Gas |
| | nonaqueous | | electrolytic | | electrolytic | retention | generation |
| | electrolytic solution | | solution) | | solution) | rate | amount |
| | (volume ratio of solvent) | Kind | (% by mass) | Kind | (% by mass) | (%) | (%) |
| Example 18 | 1.2M LiPF₆ | Vinylsulfonyl | 1 | — | — | 79 | 78 |
| | EC/PC/DEC | fluoride | | | | | |
| | (25/5/70) | | | | | | |
| Example 19 | 1.2M LiPF₆ EC/PC/DEC (25/5/70) | | 1 | 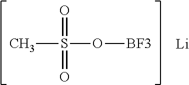 | 0.5 | 83 | 73 |
| Comparative | 1.2M LiPF₆ | — | — | — | — | 59 | 100 |
| Example 11 | EC/PC/DEC | | | | | | |
| | (25/5/70) | | | | | | |

From comparison of Examples 16 and 17 with Comparative Example 10 in Table 3, even in the case of using lithium nickel manganate (LiNi_{1/2}Mn_{3/2}O₄) for the positive electrode, similarly to Examples 1 to 15, the effects for not only improving the high-voltage cycle property but also suppressing the gas generation amount are brought.

In addition, from comparison of Examples 18 and 19 with Comparative Example 11 in Table 4, even in the case of using lithium titanate (Li₄Ti₅O₁₂) for the negative electrode, similarly to Examples 1 to 15, the effects for not only improving the high-voltage cycle property but also suppressing the gas generation amount are brought.

In consequence, it is clear that the effects of the present invention are not effects relying upon a specified positive electrode or negative electrode.

Furthermore, the nonaqueous electrolytic solution of the present invention also has effects for improving the discharging properties in the case of using a lithium primary battery at a high voltage and the charging and discharging properties of a lithium ion capacitor.

### INDUSTRIAL APPLICABILITY

The energy storage device using the nonaqueous electrolytic solution of the present invention is useful as an energy storage device, such as a lithium secondary battery, a lithium ion capacitor, etc., each having excellent electrochemical characteristics in the case of using a battery at a high voltage.

1. A nonaqueous electrolytic solution having an electrolyte salt dissolved in a nonaqueous solvent, the nonaqueous solvent comprising a cyclic carbonate and a linear carbonate under the following condition 1 or 2, and the nonaqueous electrolytic solution comprising from 0.001 to 5% by mass of vinylsulfonyl fluoride:
condition 1: the linear carbonate comprises both a symmetric linear carbonate and an asymmetric linear carbonate, and the proportion of the asymmetric linear carbonate occupying in the linear carbonate is from 51 to 95% by volume; and
condition 2: the cyclic carbonate comprises ethylene carbonate and propylene carbonate, and the linear carbonate comprises a symmetric linear carbonate.

2. The nonaqueous electrolytic solution according to claim 1, wherein the cyclic carbonate comprises one or more selected from ethylene carbonate, propylene carbonate, 1,2-butylene carbonate, 2,3-butylene carbonate, and a cyclic carbonate having a fluorine atom or an unsaturated bond.

3. The nonaqueous electrolytic solution according to claim 2, wherein the cyclic carbonate having a fluorine atom comprises one or more selected from 4-fluoro-1,3-dioxolan-2-one and trans- or cis-4,5-difluoro-1,3-dioxolan-2-one.

4. The nonaqueous electrolytic solution according to claim 2, wherein the cyclic carbonate having an unsaturated bond comprises one or more selected from vinylene carbonate, vinyl ethylene carbonate, and 4-ethynyl-1,3-dioxolan-2-one.

5. The nonaqueous electrolytic solution according to claim 1, wherein the cyclic carbonate comprises ethylene carbonate or propylene carbonate, and a cyclic carbonate having a fluorine atom.

6. The nonaqueous electrolytic solution according to claim 1, wherein the asymmetric linear carbonate is one or more selected from methyl ethyl carbonate, methyl propyl carbonate, methyl isopropyl carbonate, methyl butyl carbonate, and ethyl propyl carbonate.

7. The nonaqueous electrolytic solution according to claim 1, wherein the symmetric linear carbonate is one or more selected from dimethyl carbonate, diethyl carbonate, dipropyl carbonate, and dibutyl carbonate.

8. The nonaqueous electrolytic solution according to claim 1, wherein the electrolyte salt comprises one or more lithium salts selected from LiPF₆, LiBF₄, LiN(SO₂CF₃)₂, LiN(SO₂F)₂, lithium bis[oxalate-O,O′]borate (LiBOB), and lithium difluorobis[oxalate-O,O′]phosphate.

9. The nonaqueous electrolytic solution according to claim 8, wherein the concentration of the lithium salt is from 0.3 to 2.5 M relative to the nonaqueous solvent.

10. An energy storage device comprising a positive electrode, a negative electrode, and a nonaqueous electrolytic solution having an electrolyte salt dissolved in a nonaqueous solvent, the nonaqueous solvent comprising a cyclic carbonate and a linear carbonate under the following condition 1 or 2, and the nonaqueous electrolytic solution comprising from 0.001 to 5% by mass of vinylsulfonyl fluoride:
condition 1: the linear carbonate comprises both a symmetric linear carbonate and an asymmetric linear carbonate, and the proportion of the asymmetric linear carbonate occupying in the linear carbonate is from 51 to 95% by volume; and
condition 2: the cyclic carbonate comprises ethylene carbonate and propylene carbonate, and the linear carbonate comprises a symmetric linear carbonate.

11. The energy storage device according to claim 10, wherein an active material of the positive electrode is a complex metal oxide of lithium comprising one or more selected from cobalt, manganese, and nickel, or a lithium-containing olivine-type phosphate comprising one or more selected from iron, cobalt, nickel, and manganese.

12. The energy storage device according to claim 10, wherein an active material of the negative electrode comprises one or more selected from a lithium metal, a lithium alloy, a carbon material capable of absorbing and releasing lithium, tin, a tin compound, silicon, a silicon compound, and a lithium titanate compound.

13. The energy storage device according to claim 11, wherein an active material of the negative electrode comprises one or more selected from a lithium metal, a lithium alloy, a carbon material capable of absorbing and releasing lithium, tin, a tin compound, silicon, a silicon compound, and a lithium titanate compound.
